(19) United States
(12) Patent Application Publication
(10) Pub. No.: US 2026/0094603 A1
(43) Pub. Date: Apr. 2, 2026

(54) LONG-FORM CONVERSATION SIMULATOR

(71) Applicant: Microsoft Technology Licensing, LLC, Redmond, WA (US)

(72) Inventors: Amy SHAH, Bothell, WA (US); Bert CASPER, Redmond, WA (US); Sayan Dev PATHAK, Kirkland, WA (US); Christopher Hakan BASOGLU, Everett, WA (US); Alberto Alonso FLORES, Elkridge, MD (US)

(21) Appl. No.: 18/901,084

(22) Filed: Sep. 30, 2024

(51) Int. Cl. G10L 15/183; G10L 13/033; G10L 13/08; G10L 15/06; G10L 15/18; G10L 25/63

(52) U.S. Cl. CPC G10L 15/183; G10L 13/033; G10L 13/08; G10L 15/063; G10L 15/1815; G10L 25/63; G10L 2015/0635

(57) ABSTRACT

A method for simulating a long-form conversation includes instructing a language model to simulate a conversation by generating dialog associated with a primary topic; receiving, from the language model, a short-form conversation transcript that includes the dialog, and dynamically extending the short-form conversation via a feedback loop that provides for identifying secondary topics based on entities referenced in the dialog; instructing the trained language model to generate additional dialog of the conversation associated with the secondary topics; receiving from the trained language model an extension of the dialog; and appending the extension to the previously-created dialog to create a long-form conversation transcript. The long-form conversation transcript may be synthesized into audio data that is usable to train a speech recognition model. In some cases, generating the audio data entails auto-generating speech synthesis markup language (SSML) annotations based on the dialog or injecting randomized disfluencies that enhance the realism of the resulting audio data.

### BACKGROUND

In modern speech-based communication applications, employing artificial intelligence (AI) models for speech-to-text conversion is becoming increasingly common. To ensure positive user experiences with applications backed by automated voice transcription technologies such as automated generation of meeting notes, summaries, follow-up tasks, and live voice-to-text chatting, it is critical that these AI models be able to accurately detect names and entities in conversation speech.

While current speech-to-text conversation models exhibit strong performance in recognizing common words, these models often struggle with recognizing out-of-vocabulary (OOV) terms due to homophonic misrecognition, such as rare human names and uncommon entities. For improved performance, it is critical that speech recognition models be trained using high-quality data sets that sufficiently represent these OOV terms. However, building a high-quality training set is a challenging task.

One challenge in obtaining quality training data sets is that audio meeting and conversation data is often subject to privacy protections and not available to use for model training without the consent of the meeting participants. Obtaining this data is laborious and time-consuming due to the fact that audio recordings and/or meeting transcripts typically have to be requested and specifically authorized for release and use. Moreover, when transcripts are obtained and then translated into audio using voice assistant AI, it is common for the AI-generated recordings to include mispronunciations and lack realistic conversational elements (e.g., pauses and people talking over one another) that a trained speech recognition model needs to be able to interpret. Further compounding the scale of this challenge is the sheer quantity of training data that is needed due largely to the fact that software products backed by speech-to-text AI features have a global market presence. Consequently, it is critical for these models to be trained on multilingual meeting data and voice data with different accents and pronunciations collected from a variety of geographic domains.

These obstacles in obtaining quality training data for speech recognition models hinder progress in the field by slowing the rate at which model updates and features can be developed and released.

### SUMMARY

According to one implementation, a method for simulating a long-form conversation includes: instructing a language model to simulate a first phase of a conversation by generating dialog associated with a primary topic; receiving, from the language model, a short-form conversation transcript that includes the dialog; storing the short-form conversation transcript as a first portion of a long-form conversation transcript; and dynamically extending the conversation via a feedback loop. The feedback loop includes operations for: identifying secondary topics based on entities referenced in the long-form conversation transcript; instructing the trained language model to simulate a next phase of the conversation by generating additional dialog associated with the secondary topics; receiving from the trained language model an extension of the conversation that includes the additional dialog referencing the secondary topics; and updating the long-form conversation transcript to include the additional dialog.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Other implementations are also described and recited herein.

### BRIEF DESCRIPTION OF THE DRAWINGS

FIG. 1 illustrates an example system that uses artificial intelligence (AI) to generate realistic long-form conversation data.

FIG. 2 illustrates additional aspects of an example system that uses AI to generate realistic long-form conversation data that can be used to train voice recognition models.

FIG. 3 illustrates aspects of an example audio generation component that generates a simulated conversation audio recording based on a long-form conversation transcript that may be generated according to the herein-disclosed technology.

FIG. 4 illustrates example operations for using AI to simulate a long-form conversation

FIG. 5 illustrates an example schematic of a processing device suitable for implementing aspects of the disclosed technology.

### DETAILED DESCRIPTION

Although language models have previously been used to generate conversation data (dialog), existing processes do not support the use of language models to generate detailed conversations that extend more than a few minutes in length. When a language model embodying presently available technology is tasked with generating dialog about a specified topic, the model may successfully generate a conversation transcript that spans a few minutes, such as less than ten minutes or less when read at normal speaking speeds. However, modern language models are highly prone to hallucinating or stopping abruptly (e.g., due to being unable to identify further relevant content to output) after generating this relatively short quantity of dialog. In general, the term “model hallucination” refers to an incorrect or misleading result output by a trained model. In the context of dialog generation, a model hallucination may assume the form of dialog that is off-topic or that circles back to repeat some of what has already been said. Model hallucinations present a major impediment to the use of artificial intelligence (AI) systems to generate meaningful longer-form content, such as dialog.

It is known that larger-scale language models (e.g., GPT models, BLOOM, Llama models) tend to hallucinate less when prompted with more direct and less open-ended instructions. Therefore, one seeming solution is to generate a long-form (e.g., hour or longer) conversation by repeatedly prompting the language model to generate mini-dialogs that can be appended together. However, when asking a language model to “elaborate” or “say more” about a particular topic, it is common for the language model to generate repetitive outputs (e.g., by repeating dialog that the model has already generated or circling back to comment on topic(s) already addressed by previous output), which is not ideal for creating realistic conversation data. Moreover, this approach of repeated prompting (e.g., “generate more dialog about [X]”) tends to result in disjointed, unrealistic dialog that abruptly topic-hops without natural transitions and/or without preserving the continuity of speakers, roles, etc.

The herein-disclosed technology provides solutions for using AI to simulate high-quality long-form conversations on directed topics that are free of hallucinations and of pre-prescribed length (e.g., 10 minutes to hours-long). According to one implementation, the disclosed technology includes a long-form conversation generator that leverages novel prompt engineering and batching techniques to generate multi-speaker, long-form conversations with customizable (e.g., OOV) entity references. Some implementations of the disclosed technology further include an audio generation component that synthesizes the AI-generated long-form conversation transcriptions into voiced audio that features customizable languages, accents, and realistic conversational disfluencies.

The highly customizable, realistic, long-form conversational data that is generated using the herein-disclosed technology can be created much more quickly and easily than the pace and ease at which it is possible to request and obtain authentic conversational audio of comparable quality. This makes it possible to propel advancements in speech recognition AI by using the herein-disclosed synthetically-generated long-form conversational audio data generated to train high-performing speech recognition models.

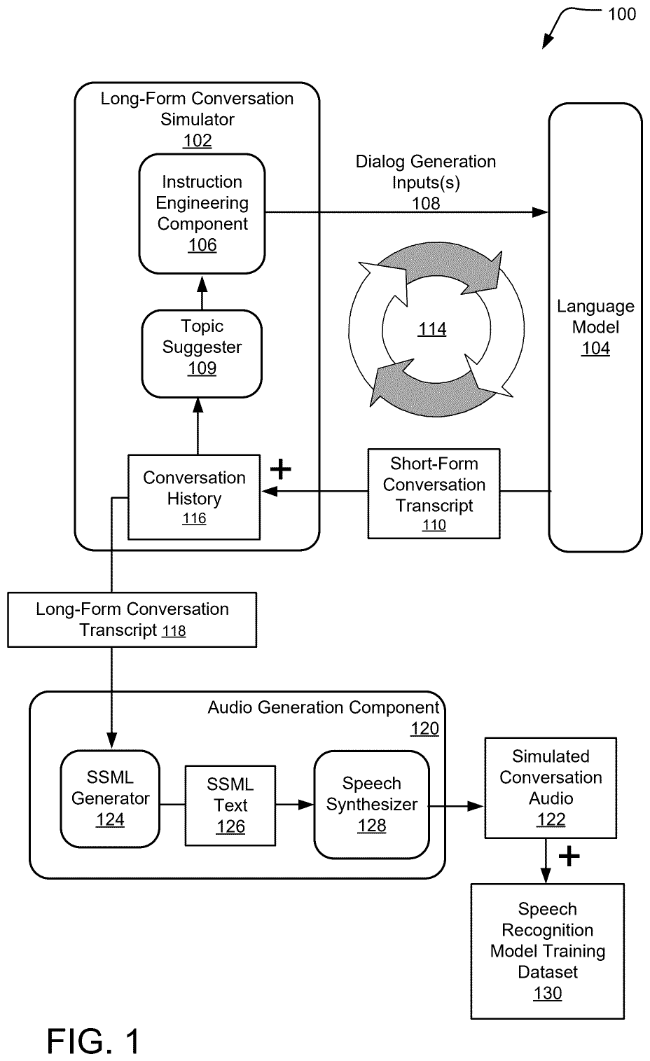

FIG. 1 illustrates an example system 100 that generates realistic long-form conversation data that is customizable for OOV entity references and for multi-domain representations of languages, accents, and pronunciations. The system includes a long-form conversation simulator 102 that interacts with a language model 104 to generate long-from conversation transcripts (e.g., in textual form). Examples of language models suitable for implementing the disclosed technology include transformer-based models (e.g., a generative pre-trained transformer (GPT) model, an Open Pretrained Transformer (OPT) model, Bioscience Large Open-science Open-access Multilingual (BLOOM) model), as well as seq2seq models, long short-term memory (LSTM) networks, and recurrent neural networks (RNNs). As used herein, “language model” refers to a trained model of any size (e.g., large language model (LLM) or small language model (SLM) that is capable of processing inputs representing language. While this class of trained models includes natural language processing (NLP) models that process language in textual form, it also includes certain multimodal models that can receive prompts that include various types of input (e.g., text, image, audio, and/or video data) and likewise generate outputs of various types that are not necessarily the same as the input type. Examples of multimodal language models include the Mistral AI model and the large language model Meta AI (LLaMa) model.

The long-form conversation simulator 102 of FIG. 1 includes an instruction engineering component 106 interfaces with a language model 104 to generate and iteratively extend conversational dialog pertaining to a same, simulated conversation. This iterative extension of dialog is achieved by multiple, repeated instances of a feedback loop 114 that includes dialog generation inputs(s) 108 (e.g., instruction prompt(s), files, or other data) as input to the language model 104 followed by receipt of a short-form conversation transcript 110 as output, where each different instance of the short-form conversation transcript 110 includes dialog pertaining to one or more different topics that have some natural association (discussed further below) with the topic(s) discussed in previous instances of the short-form conversation transcript 110 generated as part of the same conversation.

As used herein, the terms “short-form conversation transcript” and “long-form conversation transcript” are intended to impart relative meaning to one another, with the term “short-form conversation transcript” referring to a transcript that is shorter in length than a “long-form conversation transcript. ” In one implementation, the short-form conversation transcript has a total text size that can be generated by the language model 104 in response to a singular input instruction (e.g., prompt) without causing the language model 104 to hallucinate or repeat itself. Due to variability in language model capabilities, the length of the short-form conversation transcript 110 may vary depending upon the identity of the language model 104; however, an example length of the short-form conversation transcript is anywhere from a few seconds to a few minutes (e.g., 5-10 minutes) when read aloud at normal speaking speeds. In contrast to “short-form conversation transcript”, the term “long-form conversation transcript” (e.g., long-form conversation transcript 118) used herein to refer to a transcript that is created based on an aggregation of multiple different short-form conversation transcripts (e.g., short-form conversation transcript 110). An example length of the long-form conversation transcript 118 is ten minutes to an hour or more.

The dialog generation inputs(s) 108 define at least one topic to be discussed during each phase of conversation and further define characteristic(s) of participants to the conversation, such as by defining names of the participants, geographical locales of the participants, spoken languages of the participants, and/or roles for each participant. In some implementations, the dialog generation input(s) 108 are also engineered to identify select (customizable) entities that the language model is instructed to reference within the generated dialog. The customizability of these entities, along with the participant descriptions, allows the disclosed technology to be used to generate long-form conversational data that is sufficiently representative of rare entities, accents, pronunciations, etc., that may be underrepresented in donated audio data.

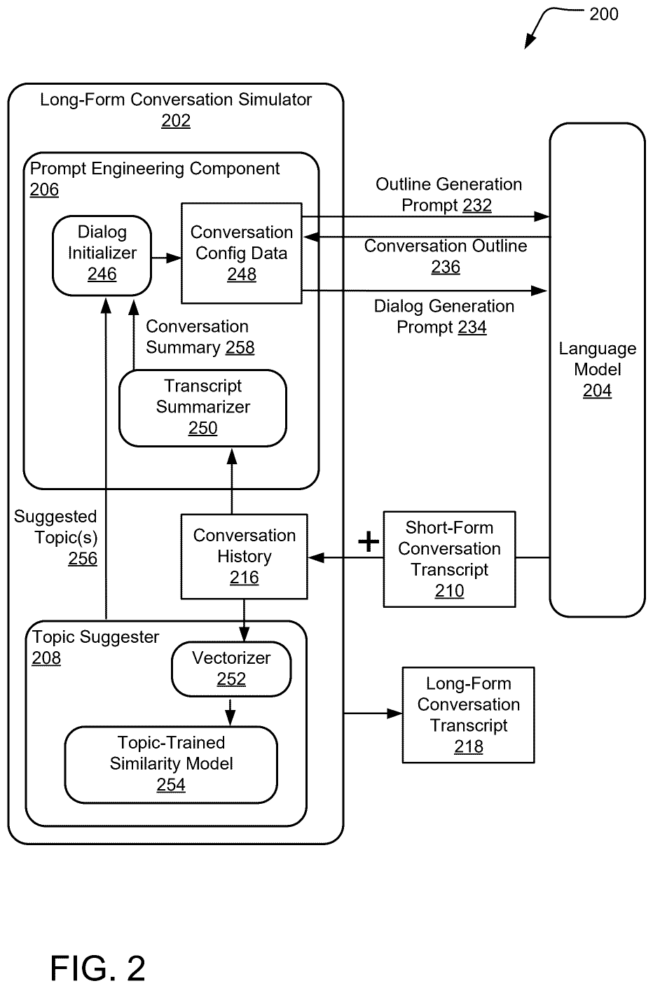

The dialog generation input(s) 108 may include a single language model prompt or multiple language model prompts, with some output from the language model 104 being received by the long-form conversation simulator 102 between each prompt. Notably, FIG. 2 illustrates an implementation in which each dialog generation instruction is broken down into two separate language model prompts representing sub-tasks in dialog generation.

On each sequential instance of the feedback loop 114, the language model 104 is instructed to simulate a different phase of a conversation that includes dialog associated with one or more new topics that have some relation to the previous topic(s) discussed due to the methodology of their selection, which is further discussed below. The topics are selected by a topic suggester 109 and vary on each iteration of the feedback loop 114.

In response to receiving each instance of the short-form conversation transcript 110, the long-form conversation simulator 102 appends the short-form conversation transcript 110 to a conversation history 116, which includes a full transcript of the ongoing conversation. After being appended with the newest conversation dialog, a topic suggester 109 analyses the conversation history 116 (in some cases, with emphasis on the newest dialog of the conversation) to identify secondary topics to discuss in the next phase of the ongoing conversation. This identification of secondary topics is based, at least in part, on the identification of entities that have already been referenced in the conversation.

In one implementation, the topic suggester 109 includes a semantic model (referenced elsewhere herein as “topic-trained similarity model”) that has been trained to recognize relations between different topics. For example, the semantic model encodes different portions of a hierarchical ontology as different embeddings in a vector space in which spatial proximity between the embeddings is correlated with similarity between the associated terms. In this implementation, the topic suggester 109 stores the conversation history 116 and/or each instance of the short-form conversation transcript 110 as a different embedding in the same latent vector space and performs a vector analysis (e.g., a dot product or cosine similarity) to identify the stored embedding(s) of the hierarchical ontology that are most related to the conversation. For example, the topic suggester 109 performs the aforementioned vector analysis to identify a set number of N topics with similarity to topics/entities already referenced in the conversation history 116. In some implementations, the topic suggester 109 filters those topics to redact topics already discussed in the conversation before passing a filtered list of topics back to the instruction engineering component 106.

Upon receiving the suggested topics (“secondary topics”) from the topic suggester 109, the instruction engineering component 106 again generates the dialog generation input(s) 108, which instruct the language model 104 to simulate the next phase of the conversation by generating dialog pertaining to the secondary topic(s) that builds on the previous conversation between the same participants. In response to these instructions, the language model 104 outputs another instance of the short-form conversation transcript 110 that extends the previously generated dialog with new dialog referencing the secondary topics. The newest dialog is then added to the conversation history 116; new topics are again suggested by the topic suggester 109, and the feedback loop 114 repeats.

In response to each instance of the dialog generation input(s) 108, the language model 104 outputs another instance of the short-form conversation transcript 110. Within the same long-form conversation, each instance of the short-form conversation transcript 110 includes dialog exchanged among the same set of conversation participants that pertains to the topic(s) identified by the topic suggester 109 in the most recent instance of the feedback loop 114. After a predefined number of iterations of the feedback loop 114 have executed (or after the aggregated dialog reaches a predefined length limit or satisfies other criteria), the feedback loop 114 is terminated. At this point in time, the long-form conversation simulator 102 outputs the long-form conversation transcript 118, which is a textual transcript that includes the instances of the short-form conversation transcript 110 appended to one another sequentially, in the order of generation.

The long-form conversation transcript 118 is the product of the above-described methodology that batches the task of generating a long-form conversation into multiple directed sub-tasks that each yield dialog about one or more topics with a relational nexus (e.g., within a hierarchical ontology of related topics) to another topic already discussed within the same conversation. This batching of targeted topic-specific instructions ensures each instance of the short-form conversation transcript 110 is free of model hallucinations. Moreover, the dynamic selection of new topics based on previous topics provides natural continuity between topics, ensuring there is no misplaced or awkward “topic hopping” while also helping to ensure that the language model 104 does not repeat itself (as is often the case if the language model 204 is asked to “elaborate”on a single topic).

The long-form conversation transcript 118 is output to the audio generation component 120 that is tasked with automatically generating a realistic audio recording, shown as “simulated conversation audio 122” of the long-form conversation transcript 118. The audio generation component 120 includes a speech synthesis markup language (SSML) generator 124 that translates the long-form conversation transcript 118 into an SSML representation, shown as SSML text 126. Examples of currently available SSML generators that assist with or fully automate the task of generating SSML from text include Amazon Polly® (a tool that provides SSML support for adding emphasis, breaks, speech rate adjustments, and more), Google Cloud Text-to-Speech® (a tool that supports SSML with features such as controlling pitch, volume, speed, and pronunciation), Microsoft Azure Cognitive Services® (e.g., a set of tools that offer SSML to customize voice, rate, and tone), and ResponsiveVoice® (a web-based application programming interface (API) that supports SSML for customizing speech synthesis in web applications). The SSML generator 124 provide functionality similar to some or all of these tools in addition to providing the specific additional functionality discussed below. The SSML text 126 output by the SSML generator 124 includes annotations that associate various speech synthesis attributes with different dialog and/or different conversation participants. These annotations affect how the corresponding text is represented in audio form. Examples of speech synthesis attributes include speaking speech volume, speaking style, tone, and more.

In one implementation, the SSML generator 124 intelligently assigns different speech synthesis attributes to different dialogs within the long-form conversation transcript 118 based on participant descriptions (e.g., pertaining to geographic locale or participant role) that appear within the dialog generation input(s) 108. In other implementations, the SSML generator 124 includes one or more machine learning models trained to assign speech synthesis attributes to dialog based on an assessment of the content discussed within the dialog. For example, a model may be trained to analyze spoken content and assign appropriate emotions consistent with spoken terms or phrases that can be understood as conveying implicit emotion. For example, language such as “unfortunately . . . ”or “I wish that were the case . . . ” may implicitly convey disappointment, while other phrases may be read as suggesting urgency, frustration, excitement, and more. Emotions implicit in written language can, in this way, be extracted by the SSML generator 124 and included in the annotations of the SSML text 126. These annotations serve to ensure that AI-generated voicing is animated to convey the same emotion(s).

The SSML text 126 is provided as input to a speech synthesizer 128, which uses AI voicing to translate the SSML text 126 into the simulated conversation audio 122. The simulated conversation audio 122 is a long-form conversation (e.g., typically a half hour or more at normal playback speed) with AI voicing for the conversation participants being enhanced by realistic conversational attributes that are represented within the annotations of the SSML text 126. The highly customizable nature of the conversation participants, as well as the conversation content (e.g., pertaining to rare entities), make the simulated conversation audio 122 well-suited for inclusion in a training dataset for a speech recognition model (shown as speech recognition model training dataset 130).

In one implementation, the above-described operations are repeated to generate audio for thousands of long-form conversations, each having customized content between participants with diverse and customizable characteristics. The resulting dataset includes a sufficient distribution of rare entity mentions among participants with diverse names, accents, pronunciations, and more, all of which are extremely difficult to sufficiently capture within a training dataset consisting of audio received from non-synthetic audio sources (e.g., donated audio). Using this technology to produce training data for voice recognition models can, therefore, dramatically decrease the time and cost of model training while also improving the end performance of such models due to the fact that the training data is of higher quality than that which is organically available from non-synthetic audio sources.

FIG. 2 illustrates additional aspects of an example system 200 that uses AI to generate realistic long-form conversation data that can be used to train voice recognition models. The system 200 includes a long-form conversation simulator 202 and an language model 204. The long-form conversation simulator 202 includes a prompt engineering component 206 that engineers various prompts that cause the language model 204 to generate dialog in each of multiple iterations of a feedback loop, with each iteration of the feedback loop generating another instance of a “short-form conversation transcript 210.”

In FIG. 2, each instance of the feedback loop includes the transmission of two separate language model prompts (e.g., an outline generation prompt 232 and a dialog generation prompt 234) followed by receipt of a short-form conversation transcript 210 that includes dialog generated by the language model 204. Each instance of the short-form conversation transcript 210 includes dialog that expands on earlier conversation and discusses one or more related topics (e.g., within a hierarchical ontology of terms) to topics discussed earlier in the conversation. The different instances of the short-form conversation transcript 210 are appended together one by one and, after a predefined number of rounds of the feedback loop, output as a long-form conversation transcript 218.

In FIG. 2, the prompt engineering component 206 includes a dialog initializer 246 that performs data preparation operations to commence each new phase of the conversation (e.g., the start of each new feedback loop). To initialize a brand-new conversation, the dialog initializer 246 generates conversation configuration data 248, which is used to define the characteristics of the new conversation.

The conversation configuration data 248 defines various meeting set-up information, such as the batch size (e.g., how many rounds of the feedback loop are to execute) and a geographic locale where the simulated conversation is to hypothetically take place. When subsequently instructing the language model 204 to generate dialog, the geographic locale of the conversation is used by the language model 204 to select the language spoken during the conversation. In some implementations, the dialog generated by the language model 204 also includes locale-specific jargon customized to the geographic locale of the conversation.

In addition to setting the batch size and local, the conversation configuration data 248 also defines each participant in the conversation by name and, optionally, by other description information, such as gender, locale (e.g., if different from the locale of the meeting), language(s) spoken by the participant, and a role for the participant in the meeting. In various implementations, the “role” of each participant may be defined with different levels of detail. For example, a participant's role could be “meeting leader/organizer” or “non-leader/meeting invitee.” Alternatively, some implementations assign more specific roles, such as employment titles, to the meeting participants. For example, one participant's role is the “head of the human relations department” while another speaker's role is the “principal investigator of stem cell research development team”). Notably, the language model 204 may be capable of making inferences pertaining to how people with different roles engage in conversation. In one implementation, the language model 204 is instructed to generate dialog for each meeting participant that is consistent in tone or style with the respective role assigned to the meeting participant.

In addition to identifying the conversation participants, the conversation configuration data 248 also identifies one or more topics to be discussed during the current conversation phase. For example, the conversation configuration data 248 may initially indicate that the primary topic of the conversation is a publication on stem-cell research. This topic information is dynamically updated each time a new phase of the conversation commences.

In some implementations, the conversation configuration data 248 also defines an “entity list” that identifies names of specific entities to be referenced during the current conversation phase. For example, the entities can include human names, places, technical terms, and more. When the system 200 simulates conversations for inclusion in ML model training datasets, it can be important to ensure that the simulated conversations include a sufficient number of references to rare (OOV) entities. In one implementation, a statistical approach is employed to auto-populate the “entity list” in the conversation configuration data 248 while repeatedly simulating multiple different conversations, thereby using the system 200 to generate a training set that includes many long-form conversations that collectively include a target distribution of OOV entity mentions.

In the implementation shown, the prompt engineering component 206 transmits dialog generation instructions in the form of a sequence of prompts that command separate sub-tasks. First, the prompt engineering component 206 transmits the outline generation prompt 232. The outline generation prompt 232 includes the conversation configuration data 248 and instructs the language model 204 to generate an outline for a conversation that is conducted between the conversation participants named in the conversation configuration data 248. The prompt further instructs that the outline is to include talking points (sub-topics) related to the topic(s) named in the conversation configuration data 248. In response to the outline generation prompt 232, the language model 204 generates and returns a conversation outline 236. The prompt engineering component 206 then generates a second prompt - the dialog generation prompt 234. This second prompt passes the conversation outline 316 back to the language model 204 along with an instruction to generate dialog between the conversation participants that follows the conversation outline 236.

In different implementations, the outline generation prompt 232 may instruct the language model 204 to include different details in the conversation outline 236. However, a key purpose of this outline generation task is to generate talking points (e.g., sub-topics) for dialog in advance of generating the dialog itself. Notably, when asking an language model 204 to generate content about a particular topic, it is common for the language model 204 to return a few paragraphs and then hallucinate (mentioning unrelated content) or terminate abruptly due to failure to being able to identify content that is relevant to the question with at least a threshold certainty. However, if the language model 204 is provided with a detailed list of sub-topics for a dialog, the language model 204 is much more capable of creating a dialog about the sub-topics without hallucinating or abruptly terminating the output sequence.

Assume, for example, that the conversation configuration data 248 identifies the primary conversation topic as being “a stem-cell research paper submitted for publication.” In this scenario, the outline generation prompt 232 instructs the language model 204 to generate an outline of talking points relevant to a discussion pertaining to “a stem-cell research paper submitted for publication.” The language model 204 then generates the conversation outline 236, which includes the requested talking points. For example, the conversation outline 236 may identify sub-topics such as the deadline for submission of the research paper, the need to fact-check certain statements in the paper, solicit additional peer review, and an upcoming conference where the paper is to be submitted. These more detailed (model-generated) talking points are then included in the dialog generation prompt 234, which additionally includes some or all of the conversation configuration data 248.

The dialog generation prompt 234 instructs the language model 204 to generate dialog between the identified participants that follows the outline of talking points identified in the conversation outline 236. In some implementations, the dialog generation prompt 234 additionally instructs the language model 204 to generate the dialog for each participant to match the participant's “role” or identity information. If, for example, a conversation participant has the role of “CEO,” the language model 204 may (based on its training data and understanding of CEO posturing) infer the participant is to speak frequently, prompt others for status updates, and delegate tasks. If, in contrast, any participant in the same conversation has the role of “research scientist,” the research scientist is likely to speak less frequently than the CEO but also likely to use an authoritative tone and technical jargon due to being an expert in a very nuanced technical field. In some cases, the language model 204 may utilize the participant descriptions within the conversation configuration data 248 when crafting dialog for a participant, such as by using the participant's “geographic locale” or “languages spoken” to select a dialect to be reflected in dialog spoken by that participant.

In implementations that include an “entity list” in the conversation configuration data 248, the dialog generation prompt 234 also instructs the language model 204 to reference the entities in the entity list within the dialog that is generated about the talking points referenced in the conversation outline 236. In some implementations, the conversation configuration data 248 specifies a set number of times that each entity is to be mentioned (e.g., to help achieve target OOV distributions when engineering an ML training dataset), and the dialog generation prompt 234 instructs the language model 204 to reference each entity in the entity list the corresponding specified number of times within the short-form conversation transcript 210.

In some implementations, the conversation configuration data 238 initially includes or identifies one or more supplemental documents that the language model 204 is to use to infer the primary topic and/or as a source for generating the talking points (sub-topics). For example, a PowerPoint presentation or stack of emails may be included as input to the prompt engineering component 206 at the time that the system 200 is externally-commanded to generate a new conversation. These supplemental input documents are made available to the language model 204 in the outline generation prompt 232 and/or the dialog generation prompt 234, and the language model 204 generates dialog about the content of those supplemental documents.

Below is an example instance of the short-form conversation transcript 210 generated by the language model 204 during a single phase (single feedback loop) of the system 200. In this example, the conversation configuration data 248 defines two participants, Amanda and Jose. To generate this dialog, the conversation configuration data 248 initially defined the primary topic “a cure using gene therapy” and also included a list of OOV entities that were to be mentioned in the dialog. This list of OOV entities includes the names: “Moorthy”, “Jager”, “Razumov”, and “Nano.” The conversation configuration data 248 was passed to the language model 204 within an instance of the outline generation prompt 232, and the language model 204 generated an instance of the conversation outline 236 in response. This conversation outline included a list of model-identified talking points related to the primary topic including: “an upcoming conference”, “clinical trials”, and “diseases curable using gene therapy.” The conversation outline 236, was passed back the language model 204 within an instance of the dialog generation prompt 234, which instructed the language model 204 to generate dialog between the defined participants (Amanda and Jose) based on the outline and with reference to the OOV entities. The resulting short-form conversation transcript 210 is as follows:
Amanda: Hi, Jose. we Need to Start Planning for the Conference. we Are Going to Highlight our gene therapy research.
Jose: Hello, Amanda. Yes, I agree. What do you think should be our first step?
Amanda: Firstly, we need to ensure that we have a robust plan for our clinical trials. Moorthy has a lot of experience in this area and could help us out.
Jose: That sounds like a good idea. Moorthy's expertise would be invaluable. I remember Jager helped to develop the method we use in gene therapy to detect faulty genes.
Amanda: Yes, Jager did a great job there. I also learned a lot from Razumov about what clinical trials require.
Jose: That's true, Razumov certainly knows his stuff. We also need to focus on which diseases we aim to prioritize for a cure using gene therapy.
Amanda: Absolutely. Nano and Razumov had run into issues with using gene therapy to cure cancer.

The short-form conversation transcript 210 is added to conversation history 216, which is retained by the long-form conversation simulator 202 throughout the duration of the ongoing conversation. In FIG. 2, the prompt engineering component 206 is shown to additionally include a transcript summarizer 250 that accesses and generates a conversation summary 258 that summarizes the conversation history 216. In one implementation, the conversation summary 258 is passed back to the dialog initializer 246 and included in the next instance of the conversation configuration data 248 created by the dialog initializer 246.

Additionally, the conversation history 216 is used by a topic suggester 208 to generate new topics for discussion in the next phase of conversation, with the new topics being related to the topics already discussed. In the illustrated example, the topic suggester 208 includes a vectorizer 252 that vectorizes all or some (e.g., a most recent portion) of the conversation history 216. The resulting vector is defined within a latent space of the topic-trained similarity model 254, which encodes different portions of a hierarchical ontology as different embeddings in the latent space, with spatial proximity between pairs of the embeddings being correlated with similarity between the associated topics. The topic suggester 208 compares the vectorized representation of the conversation history 216 to the learned embeddings of the topic-trained similarity model 254 and identifies a subset of the learned embeddings that satisfy a similarity metric with the conversation history 216. For example, the similarity metric is determined by computing a cosine similarity between a pair of vectors (e.g. the vectorized representation of the conversation history and a learned topic embedding), and a pair of vectors is determined to satisfy the similarity metric when the corresponding cosine similarity exceeds a predefined threshold, such as 80%. The topics corresponding to this subset of embeddings comprise a set of topics that are similar (topically relevant) to the topics already discussed in the conversation. In one implementation, the topic suggester 208 filters this set of similar topics to remove topics already referenced in the conversation history 216, which helps to ensure that subsequent dialog of the same conversation is not repetitive of earlier dialog. The filtered list of topics is then passed back to the dialog initializer 246 as “suggested topics 256.”

When creating the conversation configuration data 248 during the second iteration of the feedback loop (e.g., to generate dialog for the second phase of the conversation), the conversation configuration data 248 is updated to include the conversation summary 258 and the suggested topics 256 identified by the topic suggester 208. In some implementations, the “entity list” within the conversation configuration data 248 is also updated to identify additional OOV entities (e.g., selected from a master list). The participant descriptions remain unchanged.

Once updated in this way, the conversation configuration data 248 is again passed to the language model 204 within a new instance of the outline generation prompt 232, which now instructs the language model 204 to reference the conversation summary 258 to create an outline usable to build on the prior discussion.

The language model 204 responds by generating another instance of the conversation outline 236 for the new phase of conversation. This conversation outline 226 includes new model-identified talking points (sub-topics) related to the suggested topics 256 that were included in the conversation configuration data 248. This new instance of the conversation outline 236 is then passed back to the language model 204, along with the most-recent version of the conversation configuration data 248, within a new instance of the dialog generation prompt 234. The new instance of the dialog generation prompt 234 instructs the language model 204 to use the new instance of the conversation outline 236 to generate dialog between the conversation participants that references the suggested topic(s) 256 and the entities in the entity list (if defined), and that also elaborates upon the earlier conversation, as evidenced by the conversation summary 258.

In response, the language model 204 outputs new dialog within a new instance of the short-form conversation transcript 210, which is appended to the conversation history 216 as described above. The operations proceed through additional iterations of transcript summarization, topic suggestion, updates to the conversation configuration data, and language model prompting, with each new instance of the short-form conversation transcript 210 being added to the conversation history 216.

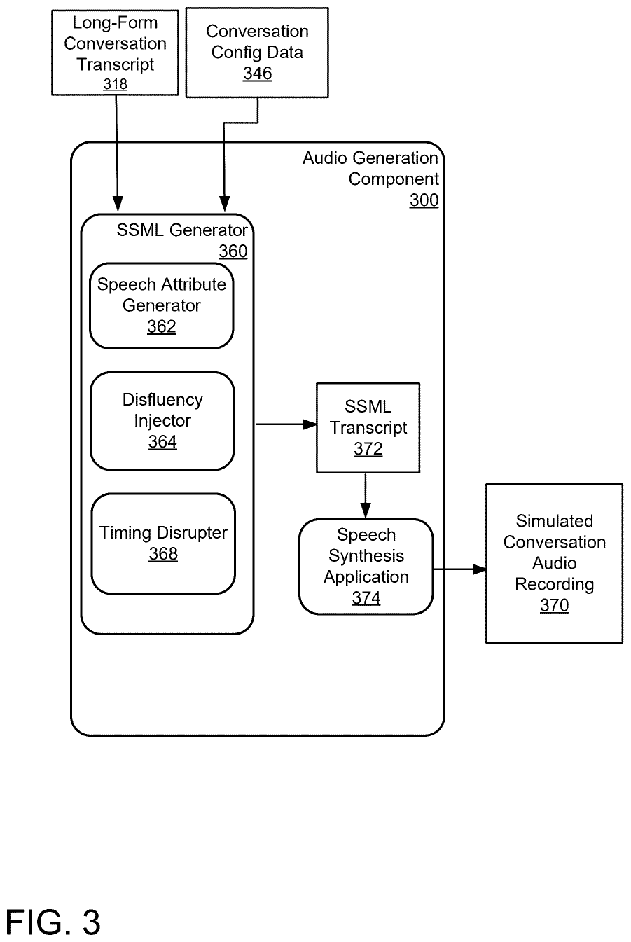

Upon completion of a predefined number of iterations of the illustrated operations, the long-form conversation simulator 202 outputs a long-form conversation transcript 218. Further example processing of the long-form conversation transcript 218 is discussed below with respect to FIG. 3.

FIG. 3 illustrates aspects of an example audio generation component 300 that generates a simulated conversation audio recording 370 based on a long-form conversation transcript 318. The long-form conversation transcript 318 includes dialog between two or more participants. The dialog may include discussion of several different topics that span significant length, such as thirty minutes or more, when read at normal talking speeds. Although not necessary for implementation, the long-form conversation transcript 318 is, in one implementation, generated via the operations described with respect to either FIG. 1 or FIG. 2. In other implementations, the long-form conversation transcript 318 is a transcript of a real conversation or a transcript that is AI-generated using techniques different than those disclosed herein.

In addition to receiving the long-form conversation transcript 318 as input, the audio generation component 300 also receives conversation configuration data 346, which includes some or all content described with respect to the conversation configuration data 346 of FIG. 2. In one implementation, the conversation configuration data 346 includes a description of each conversation participant who has a speaking role in the long-form conversation transcript 318. The description of each of the conversation participants may, for example, identify the speaker's name, geographical locale, languages spoken, and/or a defined role for the speaker, such as a role or title within an organization that that speaker is representing in the conversation or the speaker's role within the conversation (e.g., meeting organizer, presenter). In implementations where the long-form conversation transcript 318 is not AI-generated, the conversation configuration data 346 is generated for the long-form conversation transcript 318 manually or via automated process that defines characteristics of the conversation participants that may not necessarily be known for the source data.

The audio generation component 300 includes an SSML generator 360 that generates a marked-up, annotated representation of the long-form conversation transcript 318. Although it is contemplated that other formats and/or mark-up languages may be similarly used in other implementations, the audio generation component 300 includes an SSML generator 360 that creates this annotated version of the long-form conversation transcript 318 using SSML, which is an XML-based markup language that provides standardized annotations used to control aspects of the synthesis process. SSML annotations define attributes of speech that impact speech delivery, such as pronunciation, volume, pitch, speed, speaking style, and more. These attributes are collectively referred to herein as “speech synthesis attributes.”

The SSML generator 360 includes a speech attribute generator 362, which is a software tool that is preconfigured to select various speech synthesis attributes to associate with different spoken turns within the dialog. For example, the speech attribute generator 362 enforces hard-coded rules for matching various SSML speech synthesis attributes with keywords potentially appearing in various participant descriptions within conversation configuration data 346. In another implementation, the speech attribute generator 362 utilizes generative AI to select SSML speech synthesis attributes to use when synthesizing dialog of different participants. For example, the speech attribute generator 362 is trained via a supervised learning technique on a corpus of training data that includes participant descriptors (similar in form to the type of information included within the conversation configuration data 346) labeled with preselected, corresponding SSML attributes.

One example of a speech synthesis attribute that may be set automatically based on inputs to the SSML generator 360 is speaker locale. Speaker locale is a standardized SSML attribute used to influence the speaker's accent and pronunciation of words. In one implementation, the speech attribute generator 362 sets the SSML speaker locale attribute to match the locale that is included in the description of each participant in the conversation configuration data 248.

Another example of a speech synthesis attribute that may be set based on inputs to the SSML generator 360 (per the techniques generally described above) is speaker style. The SSML attribute “speaker style” can be set to emulate a variety of speaker roles such as customer service representative, newscaster, narrator, and more, as well as to emulate emotions such as excited, envious, fearful, friendly, serious, impatient, etc. In one implementation, the speech attribute generator 362 uses the participant role information included in the conversation configuration data 346 to set a default “speaker style” for some or all conversation participants. For example, the speech attribute generator 362 employs logic to match the “role” for each conversation participant (defined within the conversation configuration data 346) to a closest-matching (most relevant) speaker style, such as via predefined matching logic or a specialized model.

In one implementation, the speech attribute generator 362 includes a specialized model that is trained to assign values for the “SSML speaker style” to dialog spoken by different conversation participants based on learned semantic associations between the available values for the speaker style attribute and language that appears in the participant descriptor of each of the conversation participants (within the conversation configuration data 248). For example, the specialized model includes a language model that is specially adapted for performing the task of SSML speaker style via additional training on a corpus that includes examples of the conversation configuration data 248, including participant descriptors labeled with select, corresponding SSML speaker styles attributes that convey speaker role (e.g., “newscaster”) or emotion (“excited”).

Notably, the content of dialog can also provide clues usable to identify emotions implicit in speech that may, in a real-world scenario, alter how speech is delivered. In one implementation, the SSML generator 360 includes a model trained to identify emotions implicitly associated with dialog content. For example, supervised learning is employed by providing the model with a training corpus that includes lines of dialog pre-labeled with select, corresponding emotions. For example, certain phrases such as “that's too bad” or “unfortunately . . . ” convey disappointment, while other phrases can be interpreted as conveying impatience, excitement, anger, etc. In this implementation, the trained model identifies implicit emotions for different spoken turns in the dialog, and the SSML generator 360 matches those implicit emotions with corresponding (e.g., closest-semantically-matching) standardized values of SSML speech synthesis attributes. For example, the emotion “anger” is identified as being implicit within a spoken turn of dialog, and this emotion is then matched with the “anger” value for the SSML “speaking style” attribute. Alternatively, the SSML generator 360 includes logic for pairing an identified implicit emotion with another SSML speech synthesis attribute value, such as a value for pitch, volume, or tone of speech. Each selected speech synthesis value is captured in a corresponding dialog annotation of the SSML transcript 372.

The SSML generator 360 further includes a disfluency injector 364. In one implementation, the disfluency injector 364 alters text in the SSML transcript 372 to inject natural speech disfluency elements such as breaks, irregularities, and non-lexical vocables into the dialog. Examples of speech disfluencies include hesitations (e.g., pausing awkwardly between words), repeating a word or phrase, stuttering (e.g., having a hard time getting a word out), prolongations (e.g., stretching out a vocal sound for longer than typical), and using filler words and sounds (e.g., “mmh-mh”, “huh,” “uh,” “erm,” “um,” and “like”). Notably, different filler words are common in different geographic locales. In one implementation, the disfluency injector 364 selects a vocabulary of filler words and sounds to use within dialog spoken by a particular conversation participant based on the corresponding “participant locale” and/or the “conversation locale”information that is identified in the conversation configuration data 346.

In one implementation, the disfluency injector 364 includes randomization logic that provides for injecting disfluencies at random into different spoken turns of the conversation. This logic ensures that dialog in the SSML transcript 372 is synthesized to include a realistic number of disfluencies. For example, the total number of disfluencies to inject within a conversation is determined as a fixed ratio of the number of words or by some other suitable, objective metric.

The above-described deliberate and controlled injection of speech disfluencies enhances the realism of the simulated conversation audio recording 370 by making the resulting AI-generated audio less robotic and more resemblant of actual human speech. When a speech recognition model is trained on simulated conversation data generated in this way, the speech recognition model is more capable of accurately recognizing speech that includes natural disfluencies.

After translating the long-form conversation transcript 318 to SSML, adding annotations that assign speech synthesis attributes, injecting disfluencies into the dialog, and disrupting the timing of certain dialog elements, the SSML generator 360 outputs the SSML transcript 372. The SSML transcript 372 is then provided as input to a speech synthesizer 374, which is a speech synthesis application that synthesizes audio based on a textual representation of the audio (e.g., SSML). The speech synthesizer 374 translates the SSML transcript 372 into audio by using different voice assistants to “voice” the dialog spoken by each conversation participant, according to the speech synthesis attribute(s) defined for each dialog element as generally described above.

Audio output by the speech synthesizer 374 is input into a timing disruptor 368, which performs operations that disrupt the natural timing (e.g., sequencing) of speech within the audio. In one implementation, the timing disruptor 368 splices and/or merges audio components together in a way that mimics real-world scenarios where multiple speakers talk at the same time. Deliberately skewing the timing of some dialog elements within the simulated conversation audio recording 370 is a way to simulate natural multi-speaker speaking “conflicts.” For example, it is common in web-based meetings for participants to begin answering a question at the same time and then pause and start again. Alternatively, arguments or disputes may break out in which different speakers exchange dialog simultaneously or in close enough succession to confuse a speech recognition model. When a speech recognition model is trained on simulated conversation data that includes these instances of speech overlap, the speech recognition model is better able to accurately recognize speech that is distorted due to “noise”of temporally overlapping speech.

In one implementation, the timing disrupter 368 disrupts the natural timing of audio generated by the speech synthesis application by splicing an audio file into multiple components and then merging portions of those components together in a way that, by design, causes dialog from the end of one component to temporally overlap with dialog spoken at the beginning of the next component. In some cases, audio components may be spliced, merged, and duplicated to create new arrangements that mimic the effect of two speakers speaking over one another, followed by a pause, followed by a repetition of the previously overlapped speech without overlap (e.g., the first and second speakers speak the two dialog elements in temporal succession).

In another implementation, the audio of the long-form conversation is generated in batches, each corresponding to a different one of the short-form conversation transcripts generally discussed with respect to FIG. 2. In this implementation, the timing disruptor 368 merges together the audio files corresponding to the different short-form conversation transcripts and, during this merging, randomly overlaps speech that is near then the end of the dialog pertaining to one topic (e.g., the end of a first one of the short-form conversation transcripts) with speech that is near the beginning of dialog pertaining to another topic (e.g., the beginning of the next short-form conversation transcript). This timing of speech overlap created in this way mimics natural speaker-to-speaker overlaps that tend to happen more frequently near the end of a topic being discussed, such as instances where one speaker thinks that the discussion on the topic has ended and tries to transition to a new topic just as another speaker says something else about the previous topic.

The output of the timing disrupter 326 represents a final version of the simulated conversation audio recording 370.

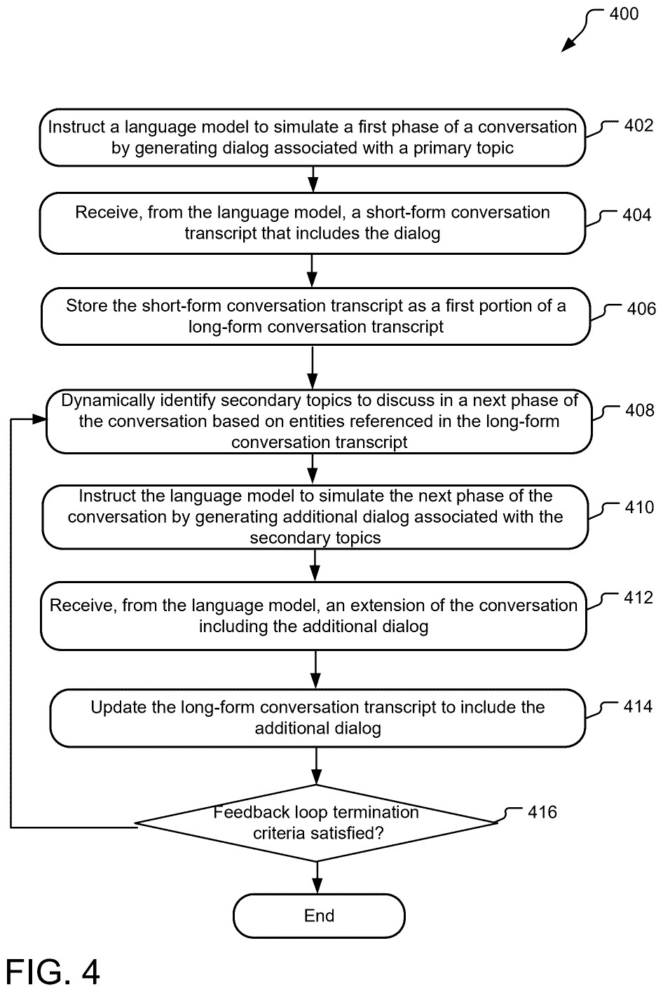

FIG. 4 illustrates example operations for using AI to simulate a long-form conversation. An instruction operation 402 instructs a language model to simulate a first phase of a conversation by generating dialog associated with a primary topic. A receiving operation receives, from the language model, a short-form conversation transcript that includes the dialog associated with the primary topic. A storing operation 406 stores the short-form conversation transcript as a first portion of a long-form conversation transcript (e.g., a transcript that is to be appended with additional dialog following each of multiple subsequent phases of the conversation).

The conversation is then dynamically extended through multiple iterations of a feedback loop that includes a topic identification operation 408, an language model instruction operation 410, a receiving operation 412, and an update operation 414. The topic identification operations 408 dynamically identifies secondary topics to discuss in a next phase of the conversation based on an analysis of entities referenced in the long-form conversation transcript. In one implementation, secondary topics are identified by a model trained to identify similarities between terms in a hierarchical ontology of terms. The model identifies topics that satisfy a similarity criterion with the entities already referenced and filters out topics already discussed to ensure the conversation does not repeat itself. The resulting list is stored as the “secondary topics.”

The instruction operation 410 instructs the language model to simulate the next phase of the conversation by generating additional dialog associated with the secondary topics. The receiving operation 412 receives, from the language model, an extension of the conversation that includes the additional dialog, and the update operation 414 updates the long-form conversation transcript to include the additional dialog.

A determination operation 416 determines whether a feedback loop termination criterion is satisfied. In one implementation, the feedback loop termination criterion is satisfied when the conversation has been extended via the feedback loop (e.g., comprising operations 408-414) a predefined number of times. In another implementation, the feedback loop termination criterion is satisfied when the long-form conversation transcript has reached a predetermined length. If the determination operation 416 determines that the feedback loop termination operation has not yet been satisfied, the operations 400 proceed back to the topic identification operation 408. Otherwise, the operations 400 end.

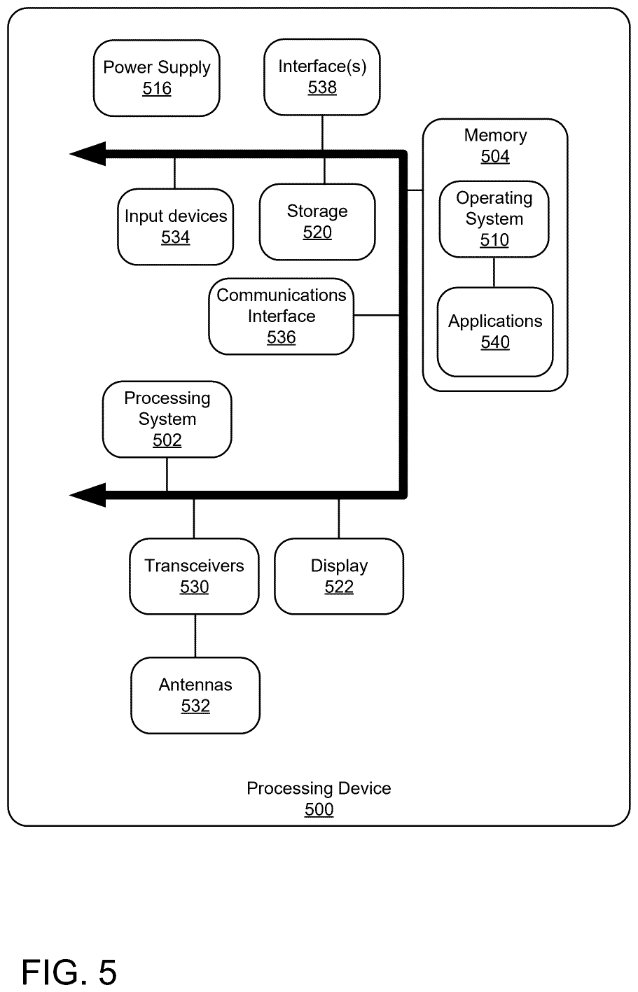

FIG. 5 illustrates an example schematic of a processing device 500 suitable for implementing aspects of the disclosed technology. The processing device 500 includes a processing system 502, memory 504, a display 522, and other interfaces 548 (e.g., buttons). The processing system 502 may have one or more computer processing units (CPUs), graphics processing units (GPUs), etc.

The memory 504 generally includes both volatile memory (e.g., random access memory (RAM)) and non-volatile memory (e.g., flash memory). An operating system 510 resides in the memory 504 and is executed by the processing system 502. One or more applications 540 (e.g., the long-form conversation simulator 102, the language model 104, or the audio generation component 120) and other data are loaded in the memory 504 and executed on the operating system 510 by the processing system 502. The applications 540 may receive inputs from one another as well as from various input local devices 534 such as a microphone, input accessory (e.g., keypad, mouse, stylus, touchpad, gamepad, racing wheel, joystick), or a camera.

Additionally, the applications 540 may receive input from one or more remote devices, such as remotely-located servers or smart devices, by communicating with such devices over a wired or wireless network using more communication transceivers 530 and an antenna 532 to provide network connectivity (e.g., a mobile phone network, Wi-Fi®, Bluetooth®). The processing device 500 may also include one or more storage devices 520 (e.g., non-volatile storage). Other configurations may also be employed.

The processing device 500 further includes a power supply 516, which is powered by one or more batteries or other power sources and which provides power to other components of the processing device 500. The power supply 516 may also be connected to an external power source (not shown) that overrides or recharges the built-in batteries or other power sources.

The processing device 500 may include a variety of tangible computer-readable storage media and intangible computer-readable communication signals. Tangible computer-readable storage can be embodied by any available media that can be accessed by the processing device 500 and includes both volatile and nonvolatile storage media, removable and non-removable storage media. Tangible computer-readable storage media excludes intangible and transitory communications signals and includes volatile and nonvolatile, removable, and non-removable storage media implemented in any method or technology for storage of information such as computer readable instructions, data structures, program modules or other data. Tangible computer-readable storage media includes RAM, read-only memory (ROM), electrically erasable programmable read-only memory (EEPROM), flash memory or other memory technology, CDROM, digital versatile disks (DVD) or other optical disk storage, magnetic cassettes, magnetic tape, magnetic disk storage or other magnetic storage devices, or any other tangible medium which can be used to store the desired information, and which can be accessed by the processing device 500. In contrast to tangible computer-readable storage media, intangible computer-readable communication signals may embody computer readable instructions, data structures, program modules or other data resident in a modulated data signal, such as a carrier wave or other signal transport mechanism. The term “modulated data signal” means a signal that has one or more of its characteristics set or changed in such a manner as to encode information in the signal. By way of example, intangible communication signals include wired media such as a wired network or direct-wired connection, and wireless media such as acoustic, radio frequency (RF), infrared and other wireless media.

Some implementations may comprise an article of manufacture. An article of manufacture may comprise a tangible storage medium (a memory device) to store logic. Examples of a storage medium may include one or more types of processor-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, operation segments, methods, procedures, software interfaces, application program interfaces (API), instruction sets, computing code, computer code, code segments, computer code segments, words, values, symbols, or any combination thereof. In one implementation, for example, an article of manufacture may store executable computer program instructions that, when executed by a computer, cause the computer to perform methods and/or operations in accordance with the described implementations. The executable computer program instructions may include any suitable type of code, such as source code, compiled code, interpreted code, executable code, static code, dynamic code, and the like. The executable computer program instructions may be implemented according to a predefined computer language, manner, or syntax, for instructing a computer to perform a certain operation segment. The instructions may be implemented using any suitable high-level, low-level, object-oriented, visual, compiled and/or interpreted programming language.

In some aspects, the techniques described herein relate to a method for simulating a long-form conversation, the method including: instructing a language model to simulate a first phase of a conversation by generating dialog associated with a primary topic; receiving, from the language model, a short-form conversation transcript that includes the dialog; storing the short-form conversation transcript as a first portion of a long-form conversation transcript; and dynamically extending the conversation via a feedback loop that includes: analyzing the long-form conversation transcript to identify referenced entities; performing a vector-based analysis to identify secondary topics with relational similarity to the referenced entities; instructing the language model to simulate a next phase of the conversation by generating additional dialog associated with the secondary topics; receiving from the language model the next phase of the conversation that includes the additional dialog associated with the secondary topics; and updating the long-form conversation transcript to include the additional dialog.

In some aspects, the techniques described herein relate to a method, further including: instructing a speech synthesizer to generate a simulated conversation audio recording of the long-form conversation transcript; and training a voice recognition model to perform audio-to-text transcription based on a training dataset that includes the simulated conversation audio recording.

In some aspects, the techniques described herein relate to a method, wherein instructing the language model to simulate the first phase of the conversation includes: generating conversation configuration data that identifies the primary topic and includes descriptions of conversation participants; transmitting to the language model a first input instructing the language model to generate a first conversation outline for the first phase of the conversation, the first input including the conversation configuration data; transmitting to the language model a second input instructing the language model to generate the next phase of the short-form conversation transcript, the second input including the first conversation outline.

In some aspects, the techniques described herein relate to a method, wherein instructing the language model to simulate the next phase of the conversation further includes: generating updated conversation configuration data that includes the secondary topics and a summary of conversation history; transmitting the language model a third input instructing the language model to generate a second conversation outline that uses the summary of the conversation history to elaborate on the dialog of conversation with reference to the secondary topics; transmitting a fourth input instructing the language model to generate another extension of the short-form conversation transcript based on the second conversation outline.

In some aspects, the techniques described herein relate to a method, wherein identifying the secondary topics to discuss in the next phase of the conversation further includes: storing the short-form conversation transcript as a conversation embedding; instructing a topic-trained similarity model to identify the secondary topics based on entities referenced in the long-form conversation transcript, the topic-trained similarity model being trained to recognize relations between different topics.

In some aspects, the techniques described herein relate to a method, wherein identifying the secondary topics to discuss in the next phase of the conversation further includes: comparing the secondary topics output by the topic-trained similarity model to the long-form conversation transcript; and filtering from the secondary topics by identifying and removing one or more topics already referenced in the conversation.

In some aspects, the techniques described herein relate to a method, further including: providing the long-form conversation transcript as input to a speech synthesis markup language (SSML) generator, the SSML generator including a model trained to identify emotions associated with dialog content; generating, by SSML generator, annotations for the long-form conversation transcript that associate different speech synthesis attributes with different spoken turns in the long-form conversation transcript, the different speech synthesis attributes being assigned based on the emotions associated with the dialog content of each of the different spoken turns; generating, by the SSML generator, an SSML representation of the long-form conversation transcript that includes the annotations; and instructing a speech synthesizer to generate a simulated conversation audio recording based on the SSML representation of the long-form conversation transcript.

In some aspects, the techniques described herein relate to a method, wherein instructing the language model to simulate a first phase of the conversation further includes: generating conversation configuration data that identifies the primary topic and that includes descriptions of conversation participants, and wherein the method further includes: selecting different speech synthesis attributes to associate with different spoken turns of the conversation based on the descriptions of the conversation participants, the different speech synthesis attributes including at least one of speaker locale or speaking style; generating an SSML representation of the long-form conversation transcript that includes annotations pairing the different spoken turns in the long-form conversation transcript with the different speech synthesis attributes; and instructing a speech synthesizer to generate a simulated conversation audio recording based on the SSML representation of the long-form conversation transcript.

In some aspects, the techniques described herein relate to a method, wherein the method further includes: randomly injecting disfluencies into the SSML representation of the long-form conversation transcript.

In some aspects, the techniques described herein relate to a method, further including: altering a temporal sequence of dialog in the long-form conversation transcript to cause multiple different meeting participants to speak simultaneously in at least a portion of a simulated conversation audio recording generated based on the long-form conversation transcript.

In some aspects, the techniques described herein relate to a system for generating training data for a voice recognition model, the system including: a long-form conversation simulator stored in memory that: instructs a language model to simulate a first phase of a conversation by generating dialog associated with a primary topic; receives, from the language model, a short-form conversation transcript that includes the dialog; stores the short-form conversation transcript as a first portion of a long-form conversation transcript; and dynamically extends the conversation via a feedback loop that includes: analyzing the long-form conversation transcript to identify referenced entities; performing a vector-based analysis to identify secondary topics with relational similarity to the referenced entities; instructing the language model to simulate a next phase of the conversation by generating additional dialog associated with the secondary topics; receiving from the trained language model the next phase of the conversation that includes the additional dialog associated with the secondary topics; and updating the long-form conversation transcript to include the additional dialog; and a speech synthesis application that generates a simulated conversation audio recording of the long-form conversation transcript.

In some aspects, the techniques described herein relate to a system, wherein the long-form conversation simulator instructs the trained language model to simulate the first phase of the conversation by performing operations that include: generating conversation configuration data that identifies the primary topic and includes descriptions of conversation participants; transmitting to the trained language model a first input instructing the trained language model to generate a first conversation outline for the first phase of the conversation, the first input including the conversation configuration data; transmitting to the trained language model a second input instructing the trained language model to generate the next phase of the short-form conversation transcript, the second input including the first conversation outline.

In some aspects, the techniques described herein relate to a system, wherein the long-form conversation simulator instructs the trained language model to simulate the next phase of the conversation by performing operations that include: generating updated conversation configuration data that includes the secondary topics and a summary of conversation history; transmitting the trained language model a third input instructing the trained language model to generate a second conversation outline that uses the summary of the conversation history to elaborate on the dialog of conversation with reference to the secondary topics; transmitting a fourth input instructing the trained language model to generate another phase of the conversation based on the second conversation outline.

In some aspects, the techniques described herein relate to a system, wherein the long-form conversation simulator is further configured to: store the short-form conversation transcript as a conversation embedding; and instruct a topic-trained similarity model to identify the secondary topics based on entities referenced in the long-form conversation transcript, the topic-trained similarity model being trained to recognize relations between different topics.

In some aspects, the techniques described herein relate to a system, wherein the long-form conversation simulator is further configured to: compare the secondary topics output by the topic-trained similarity model to the long-form conversation transcript; and filter from the secondary topics one or more topics already referenced in the conversation.

In some aspects, the techniques described herein relate to a system, further including: an audio generation component stored in memory that: analyzes dialog content of the long-form conversation transcript to identify emotions implicitly associated with different speaking turns of the conversation; assign different speech synthesis attributes to the different speaking turns based on the emotions; generates annotations for the long-form conversation transcript that associate the different speech synthesis attributes with the different speaking turns in the long-form conversation transcript; generates an SSML representation of the long-form conversation transcript that includes the annotations; and instructs the speech synthesis application to generate the simulated conversation audio recording based on the SSML representation of the long-form conversation transcript.

In some aspects, the techniques described herein relate to a system, wherein the long-form conversation transcript is generated based on conversation configuration data that identifies the primary topic and that includes descriptions of conversation participants, and wherein the system further includes an audio generation component stored in memory that: selects different speech synthesis attributes to associate with different spoken turns of the conversation based on the descriptions of the conversation participants, the different speech synthesis attributes including at least one of speaker locale or speaking style; generates an SSML representation of the long-form conversation transcript that includes annotations pairing the different spoken turns in the long-form conversation transcript with the different speech synthesis attributes; and instructs the speech synthesis application to generate the simulated conversation audio recording based on the SSML representation of the long-form conversation transcript.

In some aspects, the techniques described herein relate to a system, wherein the system further includes: an audio generation component stored in memory that: randomly injects disfluencies into the dialog of the long-form conversation transcript; and generates a simulated conversation audio recording of the long-form conversation transcript.

In some aspects, the techniques described herein relate to one or more tangible computer-readable storage media encoding processor-executable instructing for executing a computer process to simulate a long-form conversation, the computer process including: instructing a language model to generate an outline for a first phase of a conversation based on a primary topic; instructing the language model to generate dialog for the first phase of the conversation based on the outline; storing a short-form conversation transcript output by the language model as a first portion of a long-form conversation transcript; identifying secondary topics based on entities referenced in the long-form conversation transcript; instructing the language model to simulate a next phase of the conversation by generating additional dialog associated with the secondary topics; and receiving from the language model the next phase of the conversation that includes the additional dialog referencing the secondary topics; and updating the long-form conversation transcript to include the additional dialog.

In some aspects, the techniques described herein relate to one or more tangible computer-readable storage media, wherein the computer process further includes: instructing a speech synthesizer to generate a simulated conversation audio recording of the long-form conversation transcript; and training a voice recognition model based on a training dataset that includes the simulated conversation audio recording. The logical operations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language. The above specification, examples, and data, together with the attached appendices, provide a complete description of the structure and use of exemplary implementations.

What is claimed is:

1. A method for simulating a long-form conversation, the method comprising:
instructing a language model to simulate a first phase of a conversation by generating dialog associated with a primary topic;
receiving, from the language model, a short-form conversation transcript that includes the dialog;
storing the short-form conversation transcript as a first portion of a long-form conversation transcript; and
dynamically extending the conversation via a feedback loop that includes:
analyzing the long-form conversation transcript to identify referenced entities;
performing a vector-based analysis to identify secondary topics with relational similarity to the referenced entities;
instructing the language model to simulate a next phase of the conversation by generating additional dialog associated with the secondary topics;
receiving from the language model the next phase of the conversation that includes the additional dialog associated with the secondary topics; and
updating the long-form conversation transcript to include the additional dialog.

2. The method of claim 1, further comprising:
instructing a speech synthesizer to generate a simulated conversation audio recording of the long-form conversation transcript; and
training a voice recognition model to perform audio-to-text transcription based on a training dataset that includes the simulated conversation audio recording.

3. The method of claim 1, wherein instructing the language model to simulate the first phase of the conversation includes:
generating conversation configuration data that identifies the primary topic and includes descriptions of conversation participants;
transmitting to the language model a first input instructing the language model to generate a first conversation outline for the first phase of the conversation, the first input including the conversation configuration data;
transmitting to the language model a second input instructing the language model to generate the next phase of the short-form conversation transcript, the second input including the first conversation outline.

4. The method of claim 3, wherein instructing the language model to simulate the next phase of the conversation further includes:
generating updated conversation configuration data that includes the secondary topics and a summary of conversation history;
transmitting the language model a third input instructing the language model to generate a second conversation outline that uses the summary of the conversation history to elaborate on the dialog of conversation with reference to the secondary topics;
transmitting a fourth input instructing the language model to generate another extension of the short-form conversation transcript based on the second conversation outline.

5. The method of claim 1, wherein identifying the secondary topics to discuss in the next phase of the conversation further comprises:
storing the short-form conversation transcript as a conversation embedding;
instructing a topic-trained similarity model to identify the secondary topics based on entities referenced in the long-form conversation transcript, the topic-trained similarity model being trained to recognize relations between different topics.

6. The method of claim 5, wherein identifying the secondary topics to discuss in the next phase of the conversation further comprises:
comparing the secondary topics output by the topic-trained similarity model to the long-form conversation transcript; and
filtering from the secondary topics by identifying and removing one or more topics already referenced in the conversation.

7. The method of claim 1, further comprising:
providing the long-form conversation transcript as input to a speech synthesis markup language (SSML) generator, the SSML generator including a model trained to identify emotions associated with dialog content;
generating, by SSML generator, annotations for the long-form conversation transcript that associate different speech synthesis attributes with different spoken turns in the long-form conversation transcript, the different speech synthesis attributes being assigned based on the emotions associated with the dialog content of each of the different spoken turns;
generating, by the SSML generator, an SSML representation of the long-form conversation transcript that includes the annotations; and
instructing a speech synthesizer to generate a simulated conversation audio recording based on the SSML representation of the long-form conversation transcript.

8. The method of claim 1, wherein instructing the language model to simulate a first phase of the conversation further includes:
generating conversation configuration data that identifies the primary topic and that includes descriptions of conversation participants, and wherein the method further includes:
selecting different speech synthesis attributes to associate with different spoken turns of the conversation based on the descriptions of the conversation participants, the different speech synthesis attributes including at least one of speaker locale or speaking style;
generating an SSML representation of the long-form conversation transcript that includes annotations pairing the different spoken turns in the long-form conversation transcript with the different speech synthesis attributes; and
instructing a speech synthesizer to generate a simulated conversation audio recording based on the SSML representation of the long-form conversation transcript.

9. The method of claim 8, wherein the method further includes:
randomly injecting disfluencies into the SSML representation of the long-form conversation transcript.

10. The method of claim 8, further comprising:
altering a temporal sequence of dialog in the long-form conversation transcript to cause multiple different meeting participants to speak simultaneously in at least a portion of a simulated conversation audio recording generated based on the long-form conversation transcript.

11. A system for generating training data for a voice recognition model, the system comprising:
a long-form conversation simulator stored in memory that:
instructs a language model to simulate a first phase of a conversation by generating dialog associated with a primary topic;
receives, from the language model, a short-form conversation transcript that includes the dialog;
stores the short-form conversation transcript as a first portion of a long-form conversation transcript; and
dynamically extends the conversation via a feedback loop that includes:
analyzing the long-form conversation transcript to identify referenced entities;
performing a vector-based analysis to identify secondary topics with relational similarity to the referenced entities;
instructing the language model to simulate a next phase of the conversation by generating additional dialog associated with the secondary topics;
receiving from the trained language model the next phase of the conversation that includes the additional dialog associated with the secondary topics; and
updating the long-form conversation transcript to include the additional dialog; and
a speech synthesis application that generates a simulated conversation audio recording of the long-form conversation transcript.

12. The system of claim 11, wherein the long-form conversation simulator instructs the trained language model to simulate the first phase of the conversation by performing operations that include:
generating conversation configuration data that identifies the primary topic and includes descriptions of conversation participants;
transmitting to the trained language model a first input instructing the trained language model to generate a first conversation outline for the first phase of the conversation, the first input including the conversation configuration data;
transmitting to the trained language model a second input instructing the trained language model to generate the next phase of the short-form conversation transcript, the second input including the first conversation outline.

13. The system of claim 11, wherein the long-form conversation simulator instructs the trained language model to simulate the next phase of the conversation by performing operations that include:
generating updated conversation configuration data that includes the secondary topics and a summary of conversation history;
transmitting the trained language model a third input instructing the trained language model to generate a second conversation outline that uses the summary of the conversation history to elaborate on the dialog of conversation with reference to the secondary topics;
transmitting a fourth input instructing the trained language model to generate another phase of the conversation based on the second conversation outline.

14. The system of claim 11, wherein the long-form conversation simulator is further configured to:
store the short-form conversation transcript as a conversation embedding; and
instruct a topic-trained similarity model to identify the secondary topics based on entities referenced in the long-form conversation transcript, the topic-trained similarity model being trained to recognize relations between different topics.

15. The system of claim 14, wherein the long-form conversation simulator is further configured to:
compare the secondary topics output by the topic-trained similarity model to the long-form conversation transcript; and
filter from the secondary topics one or more topics already referenced in the conversation.

16. The system of claim 14, further comprising:
an audio generation component stored in memory that:
analyzes dialog content of the long-form conversation transcript to identify emotions implicitly associated with different speaking turns of the conversation;
assign different speech synthesis attributes to the different speaking turns based on the emotions;
generates annotations for the long-form conversation transcript that associate the different speech synthesis attributes with the different speaking turns in the long-form conversation transcript;
generates an SSML representation of the long-form conversation transcript that includes the annotations; and
instructs the speech synthesis application to generate the simulated conversation audio recording based on the SSML representation of the long-form conversation transcript.

17. The system of claim 14, wherein the long-form conversation transcript is generated based on conversation configuration data that identifies the primary topic and that includes descriptions of conversation participants, and wherein the system further includes an audio generation component stored in memory that:
selects different speech synthesis attributes to associate with different spoken turns of the conversation based on the descriptions of the conversation participants, the different speech synthesis attributes including at least one of speaker locale or speaking style;
generates an SSML representation of the long-form conversation transcript that includes annotations pairing the different spoken turns in the long-form conversation transcript with the different speech synthesis attributes; and
instructs the speech synthesis application to generate the simulated conversation audio recording based on the SSML representation of the long-form conversation transcript.

18. The system of claim 14, wherein the system further comprises:
an audio generation component stored in memory that:
randomly injects disfluencies into the dialog of the long-form conversation transcript; and
generates a simulated conversation audio recording of the long-form conversation transcript.

19. One or more tangible computer-readable storage media encoding processor-executable instructing for executing a computer process to simulate a long-form conversation, the computer process comprising:
instructing a language model to generate an outline for a first phase of a conversation based on a primary topic;
instructing the language model to generate dialog for the first phase of the conversation based on the outline;
storing a short-form conversation transcript output by the language model as a first portion of a long-form conversation transcript;
identifying secondary topics based on entities referenced in the long-form conversation transcript;
instructing the language model to simulate a next phase of the conversation by generating additional dialog associated with the secondary topics; and
receiving from the language model the next phase of the conversation that includes the additional dialog referencing the secondary topics; and
updating the long-form conversation transcript to include the additional dialog.

20. The one or more tangible computer-readable storage media of claim 19, wherein the computer process further comprises:
instructing a speech synthesizer to generate a simulated conversation audio recording of the long-form conversation transcript; and
training a voice recognition model based on a training dataset that includes the simulated conversation audio recording.
